(19) United States
(12) Patent Application Publication
(10) Pub. No.: US 2019/0224686 A1
(43) Pub. Date: Jul. 25, 2019

(54) PULVERIZING DEVICE FOR PULVERIZING A BASE MATERIAL, E.G. PELLETS

(71) Applicant: Klingmill AB, Torshälla (SE)

(72) Inventor: Borislav Vujadinovic, Ventspils (LV)

(21) Appl. No.: 16/373,152

(22) Filed: Apr. 2, 2019

Related U.S. Application Data
(63) Continuation of application No. 14/411,642, filed on Dec. 29, 2014.

(30) Foreign Application Priority Data
Jun. 29, 2012 (EP) 12174363.7

(51) Int. Cl. B02C 7/06; B02C 13/13; B02C 18/06; B02C 18/18; B02C 23/24

(52) U.S. Cl. CPC B02C 7/06; B02C 13/13; B02C 23/24; B02C 18/182; B02C 18/06

(57) ABSTRACT

A pulverizing device for pulverizing a base material, e.g. pellets, having a predetermined shape and size, for use in an asphalt mixture. The pulverizing device includes a pulverizing member and a pulverizing surface arranged in a housing, the pulverizing member and the pulverizing surface being arranged such that the base material is adapted to be pulverized between the pulverizing member and the pulverizing surface. The housing at least partly encloses the pulverizing member and the pulverizing surface. The pulverizing surface extends essentially along a longitudinal axis, and the pulverizing member includes a plurality of planar circular cutting discs, adapted to pulverize the base material. The cutting discs are provided with a planar surface, and the cutting discs are arranged along the longitudinal axis, such that the planar surfaces of the cutting discs are oriented essentially parallel to each other.

### RELATED APPLICATIONS

This application is a continuation of U.S. patent application Ser. No. 14/411,642 filed Dec. 29, 2014, which is a national phase of International Application No. PCT/EP2013/062144 filed Jun. 12, 2013, published in the English language and which claims priority to application Ser. No. 12/174,363.7 filed Jun. 29, 2012, all of which are hereby incorporated by reference in their entirety.

### FIELD OF THE INVENTION

The present invention relates to a pulverizing device for pulverizing a base material, e.g. pellets. The present invention further relates to an asphalt production arrangement for preparing an asphalt mixture comprising such pulverizing device for grinding a base material, e.g. pellets, according to the preambles of the independent claims.

### BACKGROUND OF THE INVENTION

Pulverizing devices have many uses, for example, they may be used for grinding or pulverizing grain and other raw materials, such as wood or metal, thus, pulverizing devices have many application areas.

One application area may be in preparation of an asphalt mixture. Asphalt is basically a mixture of aggregate and a binder, and is used as a surface course, binder course and/or base course on for example roads, airports, parking sites, etc. Generally, when preparing an asphalt mixture a predetermined amount of aggregate is heated in a drier, such that the aggregate is dried. The heat is generated by a heat source in the drier. The heat source in the drier oftentimes is a burner, which usually is run on heavy oil, diesel, coal or propane gas. When using coal as fuel it is advantageous if the coal has been pulverized to a specific fraction before it is provided to the heat source. Pulverizing the coal, such that a sufficiently small fraction is obtained, is difficult, and may be time and energy consuming.

In FR 2358966 A an example of a method for producing asphalt is disclosed. According to the method, an aggregate is heated without bitumen in a drying drum. Furthermore, the aggregate is mixed in a mixer.

The inventor of the present invention has identified a need for an improved pulverizing device with improved pulverizing action.

An object of the present invention is to provide a pulverizing device for pulverizing a base material, e.g. pellets, wherein said pulverizing device is suitable for being used in an asphalt production arrangement for preparation of an asphalt mixture.

A further object of the present invention is to provide a pulverizing device, which provides an improved pulverizing action and which provides pulverized material of a desired fraction, and a less time and energy consuming pulverizing procedure.

### SUMMARY OF THE INVENTION

The above-mentioned objects are achieved by the present invention according to the independent claim.

Preferred embodiments are set forth in the dependent claims.

In accordance with the present invention the pulverizing device for pulverizing a base material, e.g. pellets, having a predetermined shape and size, comprises a pulverizing member and a pulverizing surface arranged in a housing. The pulverizing member and said pulverizing surface are arranged such that said base material is adapted to be pulverized between said pulverizing member and said pulverizing surface. The housing is arranged to at least partly enclose said pulverizing member and said pulverizing surface. The pulverizing surface extends essentially along a longitudinal axis A, and said pulverizing member comprises a plurality of planar circular cutting discs, adapted to pulverize said base material. The cutting disc is provided with a planar surface, and said cutting discs are arranged along said longitudinal axis A such that said planar surfaces of said cutting discs being oriented essentially parallel to each other.

According to another aspect, the present invention relates to an asphalt production arrangement for preparing an asphalt mixture, said asphalt production arrangement comprises a pulverizing device as described above.

### SHORT DESCRIPTION OF THE APPENDED DRAWINGS

FIG. 1a shows schematically a pulverizing device comprising one shaft according to one embodiment of the present invention.

FIG. 1b shows schematically a cutting disc provided with a serrated cutting edge according to one embodiment of the present invention.

FIG. 2 shows schematically a pulverizing device comprising two shafts according to another embodiment of the present invention.

FIG. 3 shows schematically a pulverizing device comprising four shafts according to yet another embodiment of the present invention.

### DETAILED DESCRIPTION OF PREFERRED EMBODIMENTS OF THE INVENTION

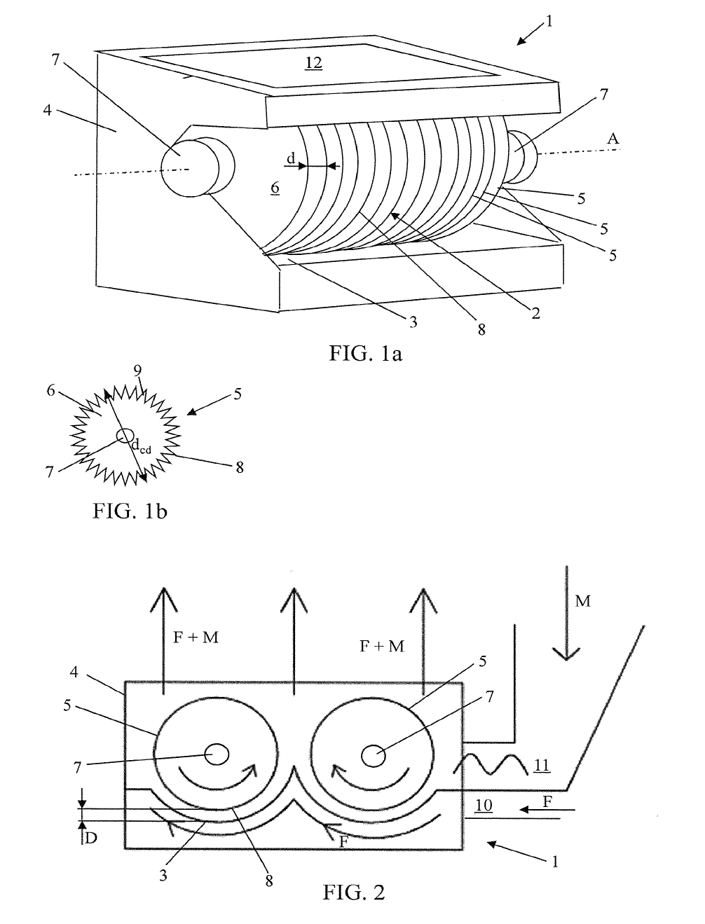

FIG. 1a shows schematically a pulverizing device 1 for pulverizing a base material, e.g. pellets, according to one embodiment of the present invention. In the drawing, one side wall has been omitted for illustrative purposes. The base material which is adapted to be pulverized has a predetermined shape and size. The pulverizing device 1 comprises a pulverizing member 2 and a pulverizing surface 3 arranged in a housing 4. The pulverizing member 2 and the pulverizing surface 3 are arranged such that the base material is adapted to be pulverized between the pulverizing member 2 and the pulverizing surface 3. The housing 4 is arranged to at least partly enclose the pulverizing member 2 and the pulverizing surface 3. The pulverizing surface 3 extends essentially along a longitudinal axis A, and the pulverizing member 2 comprises a plurality of planar circular cutting discs 5, adapted to pulverize the base material. The cutting disc 5 is provided with a planar surface 6, and the cutting discs 5 are arranged along the longitudinal axis A such that the planar surfaces 6 of said cutting discs 5 are oriented essentially parallel to each other.

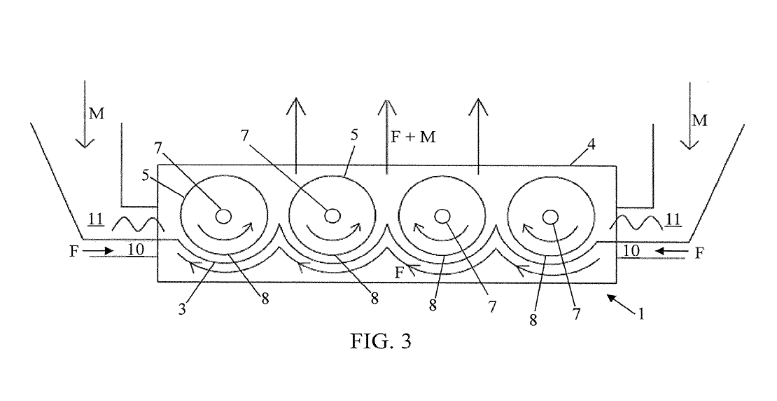

In one embodiment, as shown in FIG. 1a, an elongated shaft 7 extends along the longitudinal axis A and the cutting discs 5 are arranged along the shaft 7. Preferably, the shaft 7 extends essentially horizontally. The length of the shaft 7 may be between 60-1500 mm. According to another embodiment, there may be a plurality of elongated shafts 7 provided with cutting discs 5 arranged within the housing 4, this is illustrated in more detail in FIGS. 2 and 3.

In one embodiment, as schematically illustrated in FIG. 1b, the cutting discs 5 comprises a serrated cutting edge 8 extending along a circumference of the disc 5. In FIG. 1b, the serrated cutting edge 8 extends along the entire circumference of the cutting disc 5, however, in another embodiment, the serrated cutting edge 8 may extend partly along the circumference of the disc 5. Furthermore, the shape of the teeth 9 of the serrated cutting edge 8 may be different in different embodiments, e.g. the teeth 9 may be asymmetric. In another embodiment, the cutting disc 5 is provided with a smooth cutting edge, which is sufficiently sharp to provide the cutting action. The cutting discs 5 have a diameter d_{cd}, and the diameter is between 30-800 mm. The cutting discs 5 has a thickness, and the thickness is preferably between 0.5-20 mm. Preferably, essentially all cutting discs 5 provided along a shaft 7 have essentially the same size.

According to one embodiment, a plurality of shafts 7 is arranged within the housing 4. In case of a plurality of shafts 7, the number of shafts 7 is preferably 2-10. However, there may be any number of shafts 7 arranged within the housing 4 provided that there is enough space within the housing 4, and provided that the pulverizing surface 3 is sufficiently large.

In the embodiment illustrated in FIG. 2, the pulverizing device 1 comprises two shafts 7 provided with cutting discs 5. The shafts 7 extends essentially parallel to each other. The pulverizing surface 3 and the cutting discs 5 are arranged such that there is a distance D provided between the pulverizing surface 3 and the serrated cutting edge 8 of the cutting discs 5. The distance D may be different in different embodiments, depending on the type of material, and the predetermined shape and size of the material, which is to be pulverized. Preferably, the distance D is between 0-50 mm.

As further illustrated in the embodiment shown in FIG. 2, the cutting discs 5 are rotatably arranged in the housing 4. Preferably, the cutting discs 5 are adapted to rotate with a rate of rotation between 500-9000 rpm.

In one embodiment, the cutting discs 5 are fixed to the shaft 7, and the shaft 7 is rotatably arranged within the housing 4.

In another embodiment, the cutting discs 5 are rotatably attached to the shaft 7, individually or in groups, where each group comprises a number of cutting discs 5. Each groups or each individual cutting disc 5 may then be adapted to rotate with a different predetermined rate of rotation.

According to one embodiment, the number of discs 5 is preferably 2-200. However, the number of cutting discs 5 may be any number. Preferably, a distance d between the parallel surfaces 6 is between 0-50 mm (see FIG. 1).

In the embodiment illustrated in FIG. 2, the housing 4 comprises at least one air inlet 10 adapted to receive an air flow F. The housing 4 further comprises at least one outlet 12 adapted to discharge air F and pulverized base material M of a predefined fraction. In FIG. 2, the housing 4 comprises at least one supply opening 11 for supplying base material M to the pulverizing device 1.

According to one embodiment, the predetermined size of the base material is between (L×W×H) 0.5-6000×0.5-800×0.5-800 mm. Preferably, the base material is wood or biomass or pellets of wood or biomass. However, the pulverizing device 1 may also be applicable in the food industry, e.g. for pulverizing various types of food or corn.

According to one embodiment, the pulverizing surface 3 has a width, perpendicular to the longitudinal axis A, and a length, along the longitudinal axis A, the width being preferably 50-1400 mm and the length being between 50-2000 mm. The height of the pulverizing surface 3 is preferably between 50-1400 mm.

In one embodiment, as illustrated in FIG. 3, the pulverizing device 1 comprises four shafts 7 each one provided with a plurality of cutting discs 5. The pulverizing device 1 is provided with two air inlets 10, two supply openings 11 and at least one outlet 12. However, the number of supply openings, inlets, or outlets may be any number. As illustrated in FIGS. 2-3, in case of a plurality of shafts 7 being arranged within the housing 4, the shafts are preferably adapted to rotate in different direction. Thus, for example in FIG. 2, one shaft 7 rotates counter-clockwise and one shaft rotates clockwise. Different directions of rotation provide an improved pulverizing action and a less time consuming pulverizing procedure.

According to another aspect, the present invention relates to an asphalt production arrangement for preparing an asphalt mixture, the asphalt production arrangement comprises a pulverizing device 1 as described above. The pulverizing device is advantageous in that it provides improved pulverizing action and provides pulverized particles having a fraction less than 1 mm.

The present invention is not limited to the above-described preferred embodiments. Various alternatives, modifications and equivalents may be used. Therefore, the above embodiments should not be taken as limiting the scope of the invention, which is defined by the appending claims.

1. A pulverizing device for pulverizing wood, or biomass or pellets of wood or biomass, for being used in an asphalt production arrangement for preparation of an asphalt mixture, said pulverizing device comprising two or four elongated shafts, a plurality of pulverizing members, and a pulverizing surface arranged in a housing, wherein each pulverizing member extends along a corresponding one of the elongated shafts, each pulverizing member and said pulverizing surface being arranged relative to one another such that said wood, or biomass or pellets of wood or biomass would be pulverized between said pulverizing members and said pulverizing surface, wherein said housing is arranged to partly enclose said pulverizing members and said pulverizing surface, wherein each elongated shaft and said pulverizing surface extends along a horizontal longitudinal axis A,
wherein each pulverizing member includes a plurality of circular cutting discs for pulverizing said wood, or biomass or pellets of wood or biomass, wherein said circular cutting discs each have a planar surface, and said circular cutting discs are rotatably arranged in said housing along the corresponding elongated shaft along said longitudinal axis A such that said planar surfaces of said circular cutting discs are oriented parallel to each other, and
wherein said circular cutting discs are rotatable at a rate of rotation between 500-9000 rpm, wherein said housing comprises at least one outlet adapted to discharge air F and pulverized wood, or biomass or pellets of wood or biomass.

2. The pulverizing device according to claim 1, wherein said circular cutting discs each comprise a serrated cutting edge extending at least partly along a circumference of the respective circular cutting disc.

3. The pulverizing device according to claim 2, wherein said pulverizing surface and said circular cutting discs are arranged such that there is a distance D provided between said pulverizing surface and said serrated cutting edges of said circular cutting discs.

4. The pulverizing device according to claim 1, wherein said circular cutting discs are fixed to said shafts, and said shafts are rotatably arranged within said housing.

5. The pulverizing device according to claim 1, wherein the number of said circular cutting discs is 2-200.

6. The pulverizing device according to claim 1, wherein a distance d between said planar surfaces of said circular cutting discs is between 0-50 mm.

7. The pulverizing device according to claim 1, wherein said housing comprises at least one air inlet adapted to receive an air flow F.

8. The pulverizing device according to claim 1, wherein said circular cutting discs have a diameter d_{cd}, and wherein said diameter d_{cd} is between 30-800 mm.

9. The pulverizing device according to claim 1, wherein said circular cutting discs have a thickness, and said thickness is between 0.5-20 mm.

10. An asphalt production arrangement for preparing an asphalt mixture, said asphalt production arrangement comprises the pulverizing device of claim 1.

11. The pulverizing device according to claim 1, wherein said rate of rotation is up to 9000 rpm.

12. A method of operating the pulverising device according to claim 1, comprising pulverizing the wood, or biomass or pellets of wood or biomass.

13. The method of claim 12, further comprising discharging the air F and the pulverized wood, or biomass or pellets of wood or biomass through the at least one outlet.
